(19) United States
(12) Patent Application Publication
(10) Pub. No.: US 2008/0266193 A1
(43) Pub. Date: Oct. 30, 2008

(54) Antenna

(75) Inventor: Seung Kim, Chapel Hill, NC (US)

Correspondence Address: POTOMAC PATENT GROUP PLLC, P. O. BOX 270, FREDERICKSBURG, VA, 22404, US

(73) Assignee: Telefonaktiebolaget L M Ericsson (publ), Stockholm (SE)

(21) Appl. No.: 11/742,381

(22) Filed: Apr. 30, 2007

(51) Int. Cl. H01Q 3/02; H01Q 9/16

(52) U.S. Cl. 343/757

(57) ABSTRACT

An antenna has a 90-degree polarization separation between at least two antenna elements regardless of how a user adjusts the antenna, and yet enables the user to adjust the antenna for the best signal reception. The antenna has a pivotally adjustable structure that is configured to maintain the antenna elements at substantially a right angle with respect to each other, including a universal joint that enables the antenna to be rotated in mutually orthogonal planes. The user in one step can adjust the antenna for the best reception and simultaneously maintain optimum polarization separation between the main and the diversity antenna elements.

### BACKGROUND

This invention relates to antennas for electromagnetic signals and more particularly to such antennas for communication devices.

Diversity is one way to reduce the bad effects of signal fading in wireless radio-frequency (RF) communication systems. Space diversity uses the fact that fading is largely uncorrelated at antennas that are far enough apart. Polarization diversity uses the fact that fading is largely uncorrelated in orthogonal signal-polarization directions. Thus, a receiver can advantageously be fitted with two antennas and two respective sets of RF-signal processing devices (e.g., a low-noise RF amplifier and a down-converter). Suitably adjusting the antennas such that their positions are far enough apart and/or their polarizations are mutually orthogonal helps ensure that the base-band signal generated by at least one of the sets of processing devices will not suffer from the effects of RF-signal fading.

Wireless communication systems include wireless local area networks (WLANs) that comply with the 802.11, 802.15, and other families of standards promulgated by the International Electrical and Electronics Engineers and other organizations. Wireless communication systems also include cellular radio telephone systems that comply with the universal mobile telecommunications system (UMTS) standard, which specifies a third generation (3G) mobile system being developed by the European Telecommunications Standards Institute within the International Telecommunication Union's IMT-2000 framework. The Third Generation Partnership Project (3GPP) promulgates the UMTS standards.

3G mobile communication systems based on wideband code division multiple access (WCDMA) as the radio access technology (RAT) are being deployed all over the world. High-speed downlink packet access (HSDPA) is an evolution of WCDMA that provides higher bit rates by using higher order modulation, multiple spreading codes, and downlink-channel feedback information. Another evolution of WCDMA is Enhanced Uplink (EUL), or High-Speed Uplink Packet Access (HSUPA), that enables high-rate packet data to be sent in the reverse, or uplink, direction. New RATs are being considered for evolved-3G and fourth generation (4G) communication systems, although the structure of and functions carried out in such systems will generally be similar to those of earlier systems. In particular, orthogonal frequency division multiplexing is under consideration for evolved-3G and 4G systems.

An important application of HSDPA/HSUPA and other 3G and 4G systems is not voice but data communication. Thus, a wireless modem in the form of a PCMCIA or PC card or the even smaller ExpressCard is particularly useful in communication systems using HSDPA/HSUPA and similar arrangements.

HSDPA/HSUPA and other arrangements virtually require the use of diversity reception to minimize interference caused by adjacent RF channels/cells and meet data transmission throughput requirements. Nevertheless, it is challenging to put two antennas in the limited space of a PC card or ExpressCard and still obtain adequate signal isolation between them. Two antennas are most effective when they are separated by more than 10 times the received wave length (space diversity). If the two antennas are located close to each other, e.g., within say 2.5 centimeters of each other as they would be on an ExpressCard, it can be best bet is to forgo space diversity and obtain signal isolation from polarization diversity, where the phase of one antenna is rotated 90 degrees with respect to the phase of the other antenna.

B. A. Cetiner et al., “Small-Size Broadband Multi-Element Antenna for RF/Wireless Systems”, IEEE Antennas and Wireless Propagation Letters vol. 2, pp. 326-329 (2003) describes design aspects of an antenna that can be integrated into a PCMCIA or PC card. The antenna is built on a printed circuit board and fed by a co-planar waveguide.

Some products, such as many commercially available WLAN routers, have independently adjustable dipole antennas, one dipole as a main antenna and the other as a diversity antenna, and the user is expected to adjust the antennas for the best reception. One problem with such a fully adjustable arrangement is that many users do not understand how diversity reception works, and so they often adjust the antennas such that they achieve hardly any signal isolation.

To avoid such problems, some products have fixed antennas that users cannot adjust to obtain better signal reception. For example, U.S. Patent Application Publication No. US 2002/0101377 to Crawford describes an antenna system for cards, such as PCMCIA cards, that are used with portable computers. The antenna system has two antenna elements that are disposed at a fixed spacing on the card for achieving space diversity and that may have orthogonal polarizations for achieving polarization diversity.

For another example, U.S. Patent Application Publication No. US 2003/0210194 by Gilmore describes an antenna arrangement that can be used in PCMCIA and PC cards for devices such as notebook computers. Two antennas having different polarizations to provide signal isolation between the antennas are mounted in close proximity to each other. In one arrangement, one antenna is disposed on a hinged pop-up tab that automatically puts the two antennas into an orthogonal orientation.

L.-C. Kuo et al., “A 5 GHz Polarization-Diversity Planar Printed Dipole-Antenna for 802,11a WLAN Applications”, 2003 IEEE International Symposium on Antennas and Propagation, Columbus, Ohio, USA, June 2003, describes an arrangement of two orthogonal-polarization dipole antennas that are fed by microstrip via-hole balun structures and printed on a printed-circuit board. The arrangement may be provided in a portable computer.

Other products have two antennas that are fixed in relation to each other but that can be moved or adjusted together. For example, U.S. Pat. No. 6,031,503 to Preiss, I I et al. describes a polarization diverse antenna for portable communication devices. An antenna assembly has two folded dipoles or slot radiators that are fixed with respect to each other and orthogonally disposed in a housing such as a PCMCIA or PC card. The antenna assembly is mechanically coupled by a hinge to an electronics section including a radio transceiver, and the dipoles or radiators are electrically coupled to the transceiver by microstrip feed lines. The hinge enables spatial redirection of the antenna assembly in one plane.

For another example, U.S. Pat. No. 7,084,833 to Pintos et al. describes an antenna for portable equipment, such as television sets. Two radiating elements are fixed at 90 degrees with respect to each other and at 45 degrees with respect to a horizontal plane. One of four polarization states of the antenna is selected by a broadband switching and phase shifting electronics block.

Other products have two antennas of which one (the main antenna) is fixed and the other (the diversity antenna) is adjustable. For example, U.S. Patent Application Publication No. US 2005/0156796 to Nysen describes a multi-band antenna system for a PC card modem. The system can include two dipole antenna elements, one antenna element being mounted on the card and the other antenna element being connected to the card by a coaxial cable. Japan Patent Publication No. JP2003332930 by Hisafumi et al. describes a similar arrangement.

There are at least two problems with such arrangements. One problem is the fixed antenna, which cannot be adjusted for the best signal reception. Another problem is that the user does not know how much signal isolation is achieved as he/she adjusts the diversity antenna. If two separate signal strength indicators showing the respective signal reception strengths for the antennas are provided, the user may find that the fixed main antenna's signal reception is not so good, but it is a fixed antenna and the user cannot adjust it. The user's only option is to move the whole antenna assembly, which may be in a portable computer, around to try to find the best signal reception by the main antenna, and then re-adjust the diversity antenna for the best signal reception. Nevertheless, even if such movement is physically possible, re-adjusting the diversity antenna may change the main antenna signal reception because they are independent but interact with each other. Therefore, optimum signal reception may never be obtained.

### SUMMARY

This invention not only provides an antenna that has 90-degree polarization separation between two antenna elements regardless of how a user adjusts the antenna, but also enables the user to adjust the antenna for the best signal reception. In other words, the user in one step can adjust the antenna for the best reception and simultaneously maintain optimum polarization separation between the main and the diversity antenna elements.

In accordance with aspects of this invention, there is provided an antenna that includes a first antenna element; a second antenna element; and a pivotally adjustable structure that maintains the first and second antenna elements at substantially a right angle with respect to each other such that respective polarizations of the first and second antenna elements are separated by substantially 90 degrees. The pivotally adjustable structure includes a universal joint that enables the antenna to be rotated in mutually orthogonal planes.

### BRIEF DESCRIPTION OF THE DRAWINGS

The various objects, features, and advantages of this invention will be understood by reading this description in conjunction with the drawings, in which:

FIGS. 1A, 1B show side and front views, respectively, of an antenna in accordance with this invention; and

FIG. 2 shows a perspective view of an ExpressCard device and an antenna in accordance with this invention.

### DETAILED DESCRIPTION

It will be appreciated that the antennas described in this application can be used in a wide variety of devices, including base stations, handsets, PC Card and ExpressCard modems, and other terminals, in wireless communication systems.

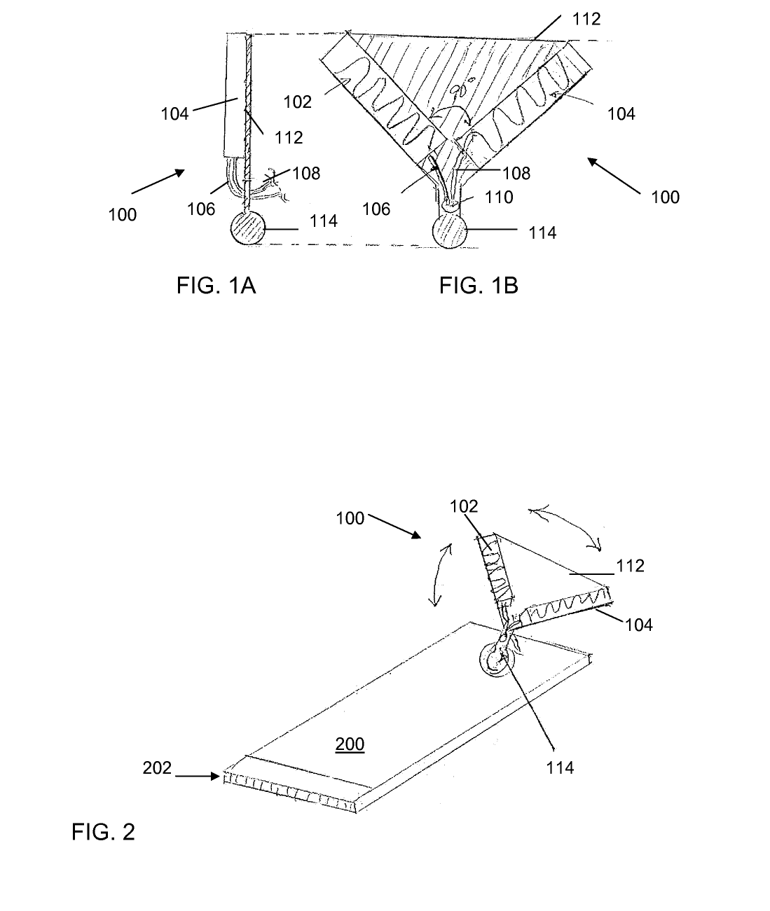

FIGS. 1A and 1B show side and front views of one implementation of an antenna 100 in accordance with this invention. The antenna 100 includes two antenna elements 102, 104, either of which may be considered a main or diversity antenna element. The antenna elements 102, 104 can be any type of radiator, such as meander, dipole, and ceramic-chip antenna elements, so long as their polarizations can be separated at a right angle or at least substantially a right angle. The antenna elements are advantageously connected to desired RF signal-processing devices, such as low-noise RF amplifiers, by respective coaxial cables 106, 108, that can pass through a suitably dimensioned hole 110 on the antenna assembly. Thin coaxial cables should be able adequately to withstand the flexing that occurs during deployment of the antenna 100 as described below.

The antenna 100 also includes a structure that maintains the antenna elements 102, 104 at a right angle or substantially so with respect to each other such that the respective polarizations of the antenna elements are separated by substantially 90 degrees. As one example of such a structure, FIGS. 1A, 1B show the antenna elements 102, 104 as fixedly attached to a substrate 112, which may be a molded thermoplastic or another suitably dimensionally stable material. Nevertheless, it will be understood that permanent fixed mounting to a substrate is not necessary and that other structures can be used. For example, the antenna elements 102, 104 may be mounted on the substrate 112 or simply pivotally joined at their ends, for example by a suitable hinge, such that they can be moved into a fixed-right-angle orientation when in use.

One suitable implementation is to lay out the antennas 102, 104 as meander antennas on a printed wiring board (PWB), which serves as the substrate 112. The meander antennas should be laid out at substantially 90 degrees to each other and co-planar on one PWB. Using a PWB or equivalent substrate advantageously facilitates matching the antennas' impedances to the impedances of the RF-signal processing devices, e.g., low-noise RF amplifiers, by enabling the use of optimized strip-wire-type antenna feed lines, such as microstrip lines, and even passive or active components, if necessary, on the substrate 112. Portions of the thin coaxial cables 106, 108 that feed meander antennas 102, 104 shown in FIGS. 1A, 1B can be implemented as impedance-matching strip wires etched on the substrate 112 and terminated at two point pads to which flexible coaxial cables can be soldered.

The structure of the antenna 100 includes a universal joint 114 that enables the antenna 100 to be rotated, preferably through about 360 degrees in one plane and at least about 180 degrees in an orthogonal plane, with respect to the mounting point of the universal joint 114. This rotatability enables the antenna 100 to be adjusted for optimal signal reception. As seen more clearly in FIG. 2, the universal joint 114 advantageously comprises a ball and a socket that are suitably dimensioned such that the socket retains the ball and yet permits rotation of the ball that is loose enough to allow finely tuned positioning of the antenna 100 and that is tight enough to retain the antenna 100 in the selected position.

FIG. 2 is a perspective view that depicts the antenna 100 deployed from an electronic device 200 in the format of an ExpressCard, which has a connector 202 that can be plugged into a matching slot of a device such as a notebook computer. In such an arrangement, the antenna 100 is preferably moved from a stowed position that is substantially in parallel with or even recessed into the surface of the device 200 and back again when the antenna 100 is not in use. When in use, the universal joint 114 enables the user to adjust the antenna 100 in almost any direction for the best signal reception without also having to consider the signal separation achieved with the antenna elements 102, 104. Thus, the user should be much more easily able to find an antenna position that yields optimal signal reception if a signal strength indicator, such as a gauge, lamp, or light-emitting diode display is provided on the device 200 or the notebook computer.

Although FIG. 2 shows the universal joint 114 more or less centered near an edge of the device 200, it will be understood that other arrangements are possible. For example, the universal joint 114 can be located at a corner of the top or bottom surface of the device 200, and such a configuration can save space when the antenna 100 is folded away. For another example, the universal joint 114 can be located on the edge of the device 200 when the antennas 102, 104 are pivotally joined at their ends. In such an arrangement, the antennas 102, 104 can be folded together against the edge of the device 200, eliminating or minimizing the need for a thickness greater than the thickness of the device 200.

It is expected that this invention can be implemented in a wide variety of environments, including for example mobile communication devices. Thus, the invention may be embodied in many different forms, not all of which are described above, and all such forms are contemplated to be within the scope of the invention.

It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

What is claimed is:

1. An antenna, comprising:
a first antenna element;
a second antenna element; and
a pivotally adjustable structure that is configured to maintain the first and second antenna elements at substantially a right angle with respect to each other such that respective polarizations of the first and second antenna elements are separated by substantially 90 degrees, wherein the pivotally adjustable structure includes a universal joint that enables the antenna to be rotated in mutually orthogonal planes.

2. The antenna of claim 1, wherein the universal joint comprises one of a ball and a socket of a ball-and-socket joint.

3. The antenna of claim 1, wherein the first and second antenna elements comprise meander, dipole, or ceramic-chip radiators.

4. The antenna of claim 1, wherein the structure comprises a substrate to which the first and second antenna elements are attached.

5. The antenna of claim 4, wherein the substrate is a molded thermoplastic material.

6. The antenna of claim 1, wherein the structure comprises a joint to which the first and second antenna elements are pivotably attached at respective ones of their ends.
